(19) United States
(12) Patent Application Publication
(10) Pub. No.: US 2007/0221274 A1
(43) Pub. Date: Sep. 27, 2007

(54) Valve plate for a reciprocating compressor

(75) Inventor: Brian Holm Andersen, Nordborg (DK)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 11/728,889

(22) Filed: Mar. 27, 2007

(30) Foreign Application Priority Data
Mar. 27, 2006 (DE) 10 2006 016 253.6

(51) Int. Cl. F16K 21/04

(52) U.S. Cl. 137/511; 251/368; 417/571

(57) ABSTRACT

The invention concerns a valve plate for a reciprocating compressor, the valve plate being made as a sintered part, having on at least one valve plate surface at least one valve seat surface (30, 31) being worked after sintering. In order to simplify the manufacturing of the valve plate, the valve plate surface has at least one defined area portion with a relatively uneven surface and at least one defined area portion with a relatively even surface.

### CROSS REFERENCE TO RELATED APPLICATIONS

Applicant hereby claims foreign priority benefits under U.S.C. §119 from German Patent Application No. 10 2006 016 253.6 filed on Mar. 31, 2006, the contents of which are incorporated by reference herein.

### FIELD OF THE INVENTION

The invention concerns a valve plate for a reciprocating compressor, the valve plate being a sintered part having on at least one valve plate surface at least one valve seat surface worked after sintering. Further, the invention concerns a method for manufacturing such a valve plate, as well as a device for stamping a valve plate surface of such a valve plate. Finally, the invention concerns a reciprocating compressor with such a valve plate.

### BACKGROUND OF THE INVENTION

From the German patent DE 40 39 786 C2, it is known to make a valve plate as a punched and stamped part. Thus, the working is limited to the punching and stamping process and to the working of the valve seats. The same patent also discloses the manufacturing of the valve plate as a sintered part. This is meant to cause that the recess can be manufactured without machining. A subsequently required working, if any, can then be restricted to the area of the valve seat. From the international patent application WO 01/63126 A1, it is known to make a valve plate of sheet steel, openings, valve seats and recesses for adopting suction and discharge valves being made in several subsequent punching and stamping steps. Manufacturing the valve plate in one single stamping step is not possible because of the too high rigidity or the too low deformability of the material, respectively.

### SUMMARY OF THE INVENTION

It is the task of the invention to simplify the manufacturing of a valve plate according to the preamble of claim 1. Further, a reciprocating compressor shall be provided, which is simple and cheap in manufacturing.

With a valve plate for a reciprocating compressor, the valve plate being a sintered part having on at least one valve plate surface at least one valve seat surface worked after sintering, this task is solved in that the valve plate surface has at least one defined area portion with a relatively uneven surface and at least one defined area portion with a relatively even surface. Making defined area portions with different degrees of evenness, enables optimal adaptation of the various area portions of the valve plate surface to their individual functions. The relatively even surface has a very narrow tolerance range with evenness tolerances in the μm-range. The relatively uneven surface can have recesses and/or projections in a wide tolerance range with evenness tolerances of several hundredths mm.

A preferred embodiment of the valve plate is characterised in that compared to the at least one defined area portion with the relatively even surface, the at least one defined area portion with the relatively uneven surface is so large that the valve plate surface concerned can be manufactured in one stamping step. It is difficult or impossible to make the complete valve plate surface with a relatively even surface in one single stamping step. Therefore, valve plates of sheet steel as known from the international patent application WO 01/63126 A1 are made in subsequent punching and stamping steps. With sintered valve plates as known from the German publication DE 40 39 786 C2, the valve seats and the recesses for the valves are stamped during a first calibration step after the sintering. Subsequently, the remaining surface of the valve plate is grinded, before the valve seats and the recesses for the valves are redone during a second calibration step. Here, the burrs occurring during grinding must be removed. The second calibration step can be made by stamping, lapping or rolling. By dividing the valve plate surface into area portions with different degrees of evenness according to the invention, the expensive machining process can be avoided. This involves the advantage that, for example, a valve plate surface sealed by means of a steam treatment is not damaged during machining.

A further preferred embodiment of the valve plate is characterised in that the at least one defined area portion with the relatively uneven surface is larger than the at least one defined area portion with the relatively even surface. This substantially simplifies the stamping of the valve plate surface. Preferably, the at least one defined area portion with the relatively uneven surface is distinctly larger than the at least one defined area portion with the relatively even surface.

A further preferred embodiment of the valve plate is characterised in that in particular only in the area of the valve seat surface the valve plate surface has a relatively even surface. The designation valve seat surface or valve seat covers the surface, on which a valve closing member of a discharge or suction valve comes to bear in the closed position. According to a substantial aspect of the invention, the remaining valve plate surface is relatively uneven.

A further preferred embodiment of the valve plate is characterised in that in the area of at least one valve body bearing surface the valve plate surface has a relatively even surface. The valve body bearing surface is the surface, on which a valve body bears constantly or can come to bear. The valve body bearing surface can be congruent with the valve seat surface.

A further preferred embodiment of the valve plate is characterised in that the valve seat surface and/or the valve body bearing surface are located in the area of recesses or projections. The valve seat surfaces and/or the valve body bearing surfaces can also end in alignment with the valve plate surface.

A further preferred embodiment of the valve plate is characterised in that an uncritical part of the relatively uneven surface has indentations or recesses, in which the sintering material, of which the valve plate is made, is locally compressed. Among other things, the indentations or recesses serve the purpose of adopting excess material.

A further preferred embodiment of the valve plate is characterised in that the indentations or recesses have a depth of a few tenths mm. These values have proven to be advantageous within the frames of the present invention.

A further preferred embodiment of the valve plate is characterised in that the indentations or recesses have the shape of a spherical segment, a truncated pyramid segment or a truncated cone segment. The shapes of the indentations or recesses depend on the stamping tool used.

A further preferred embodiment of the valve plate is characterised in that a critical part of the relatively uneven surface comprises at least one sealing zone on the valve plate surface. For example, the sealing zone serves the purpose of separating the suction side of a compressor provided with the valve plate from its discharge side. Further sealing zones serve the purpose of, for example, delimiting the compression chamber of a compressor provided with the valve plate.

A method for manufacturing a previously described valve plate involves the following steps: A preferably powdery sintering material is pressed to form a blank; the sintering material can, for example, be an unalloyed sintering iron available as powder; during the pressing the blank is provided with through-holes and/or recesses. Subsequently, the blank is sintered. According to an essential aspect of the invention, the sintered blank is then stamped during one single method step. As the manufacturing process according to the invention requires no further grinding, lapping or other machining processes over the entire surface, annular projections or beads can be made in the sealing surfaces or sealing sections or sealing zones, such projections or beads improving the tightness of a reciprocating compressor provided with such a valve plate.

A preferred embodiment of the method is characterised in that at least one valve seat surface and/or at least one valve body bearing surface is/are calibrated during the only stamping step.

A further preferred embodiment of the method is characterised in that through-holes and/or indentations and/or projections are calibrated in the only stamping step. The through-holes are primarily suction or discharge openings, as well as fixing holes.

A further preferred embodiment of the method is characterised in that the valve plate surfaces of the sintered and stamped valve plate are sealed. The sealing is made by, for example, a steam treatment.

With a device for stamping a valve plate surface of a previously described valve plate by a previously described method by means of a stamping tool, the task stated above is solved in that the stamping tool has a plurality of projections, which serve the purpose of providing indentations in the at least one defined area portion with a relatively uneven surface. In the area of the indentations, the usually porous sintering material is locally compressed during stamping. This involves the advantage that during stamping excess material is adopted in the valve plate itself, or displaced into available unevennesses. In this simple manner, predetermined thickness and/or evenness tolerances can be observed.

The invention also concerns a reciprocating compressor with a cylinder block, in which a compression chamber is formed, delimited on one side by a previously described valve plate that is clamped between the cylinder block and a cylinder head cover.

### BRIEF DESCRIPTION OF THE DRAWINGS

Further advantages, features and details of the invention appear from the following description, in which different embodiments will be described in detail with reference to the drawings, showing:

FIG. 1 is a valve plate according to the invention showing the side facing a compression chamber of a reciprocating compressor in the mounted state of the valve plate;

FIG. 2 is the side of the valve plate in FIG. 1 facing away from the compression chamber;

FIG. 3 is the view of a section along the line III-III in FIG. 1, the view direction being marked by arrows;

FIG. 4 is second embodiment of the valve plate in FIG. 1 with stamped indentations;

FIG. 5 is the side of the valve plate in FIG. 4 facing away from the compression chamber with stamped indentations;

FIG. 6 is the view of a partial section along the line VI-VI in FIG. 5, the view direction being marked by arrows.

### DETAILED DESCRIPTION OF THE INVENTION

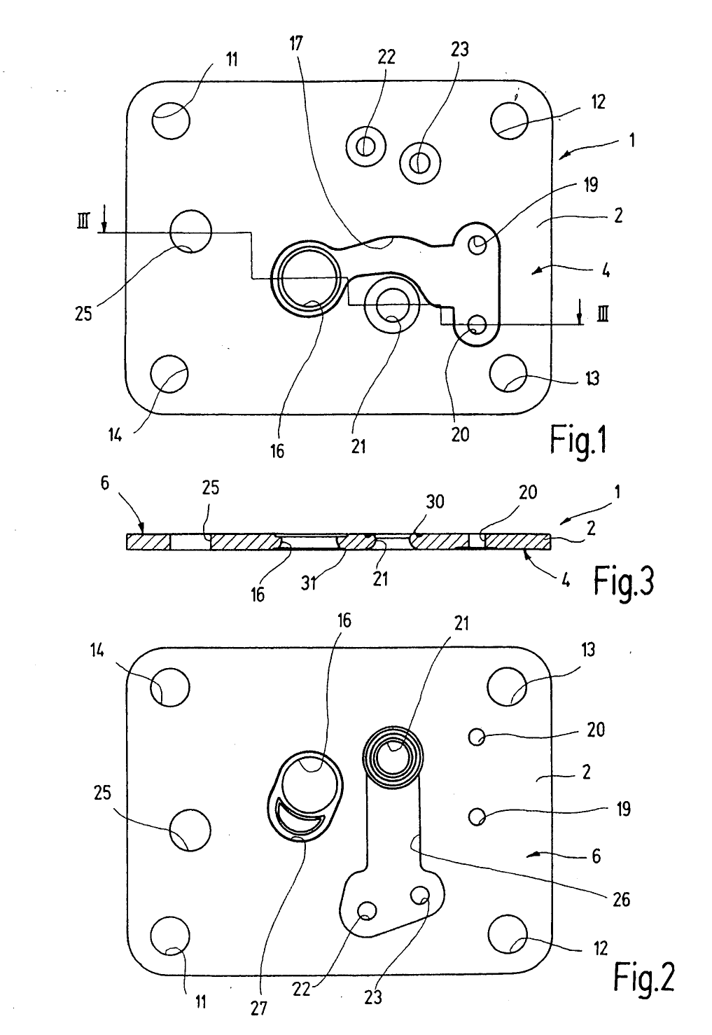

The embodiment shown in the drawings concerns a reciprocating compressor of a refrigerating machine with a cylinder head, which is fixed on the cylinder block by means of, for example, screw bolts. The cylinder block has a cylinder bore, which is also called compression chamber. The cylinder bore serves the purpose of adopting a piston of the reciprocating compressor. The cylinder head comprises a cylinder head cover and a valve plate as shown in the enclosed FIGS. 1 to 6 in different views and embodiments. A first sealing is located between the cylinder head cover and the valve plate. A second sealing is located between the valve plate and the cylinder block. In the cylinder head cover is formed a discharge chamber, which is connected to the compression chamber in the cylinder block by means of at least one through-hole in the valve plate.

The FIGS. 1 to 6 show different views and embodiments of a valve plate 1. The valve plate 1 comprises a square basic body 2 of sintered metal. The basic body 2 has a rectangular base surface, whose edges are rounded. The valve plate bottom surface facing the compression chamber and visible in FIG. 1 has the reference number 4. The valve plate surface visible in FIG. 2 and facing away from the compression chamber has the reference number 6. In the edge areas of the valve plate 1, four through-holes 11 to 14 are made for passing through fixing bolts. Therefore, the four through-holes 11 to 14 are also called bolt openings.

In a central area of the basic body 2 is provided a suction through-hole 16, which is also called suction opening. The suction through-hole 16 is located within a recess 17, serving as accommodation of a suction valve (not shown). The suction valve comprises a suction valve closing member, which serves the purpose of opening the suction through-hole 16 when refrigerant is sucked into the compression chamber of the reciprocating compressor. In the area of the recess 17 two through-holes 19 and 20 are provided, which serve the purpose of adopting fixing pins, with which the suction valve can be fixed in the recess 17.

In the vicinity of the suction through-hole 16 a discharge through-hole 21 is made in the basic body 2, which is, as appears from FIG. 2, located in a recess 26 together with two additional through-holes 22 and 23. The recess 26 serves the purpose of adopting a discharge valve (not shown), which has a discharge valve closing member that serves the purpose of communicating, during the working cycle of the piston of the reciprocating compressor, the compression chamber with the discharge chamber through the discharge through-hole 21. Between the bolt openings 11 and 14 an additional through-hole 25 is made in the valve plate 1 that serves as feed-through for discharge gas. FIG. 2 further shows that the suction opening 16 on the valve plate top side 6 is located within a recess 27 that serves the accommodation of a suction device (not shown).

FIG. 3 shows the view of a section along the line III-III in FIG. 1. The sectional view shows that the discharge opening 21 on the valve plate top side 6 is delimited by a valve seat 30, which is also called discharge valve seat surface. The suction opening 16 is delimited by a suction valve seat surface 31 on the valve plate bottom side 4.

The valve plate 1 is made of unalloyed sintering iron. According to an essential aspect of the invention, the valve plate bottom side 4 and the valve plate top side. 6 are provided with area portions with different evenness, which are made during one single stamping step without subsequent grinding. Thus, the different area portions of the valve plate bottom side 4 and the valve plate top side 6 can be optimally adapted to their function or their desired properties, respectively.

In the area of the recesses 17, 26 leaf valves come to rest in their closed position. Therefore, very small evenness tolerances are required in the area of the recesses 17 and 26. Unevennesses in these area portions, which could also be called first surface area portions, could cause increased tensional stress concentrations in the leaf valves, which again would reduce the life of a compressor provided with such a valve plate. Preferably, the area of the recess 27 also has small evenness tolerances.

With regard to the other area portions of the valve plate surface on the valve plate bottom side 4 and the valve plate top side 6, which are also called second area portions, the demands on their evenness are small, that is, larger tolerances are permitted. In the frames of the present invention, it has turned out that the required tolerances in the individual surface area portions can be achieved in one single stamping step, and a subsequent grinding can be avoided. As, compared to grinding, the stamping causes a smaller surface roughness, the risk of leakages or wear of the valves is even further reduced.

The valve plate shown in the FIGS. 1 to 3 is manufactured as follows: Providing a powdery sintering material; pressing the powder in a tool to form a blank; sintering of the valve plate blank; stamping of the valve plate; steam treatment.

Preferably, the stamping tool used has a plurality of projections, which create indentations in certain surface area portions of the sintered valve plate, as here local compressions of the usually porous sintering material take place. These surface area portions of the valve plate are part of the previously mentioned second area portions with larger evenness tolerances. In this way, “excess” material can be adopted in the valve plate itself or be displaced into available unevennesses during the stamping process, so that the predetermined thickness or evenness tolerances can be observed.

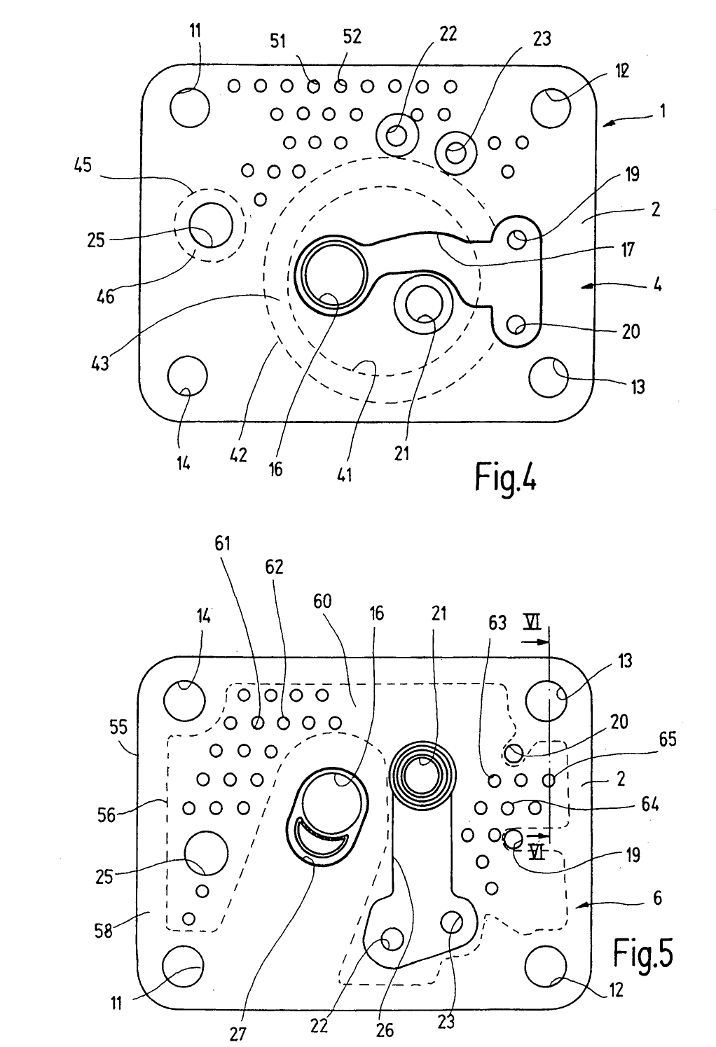

The FIGS. 4 to 6 show a similar valve plate 1 as the one shown in the FIGS. 1 to 3. Same parts have same reference numbers. To avoid repetitions, reference is made to the previous description of the FIGS. 1 to 3. In the following mainly the differences between the embodiments are discussed.

In FIG. 4, a dotted circle 41 indicates a projection of a cylinder bore on the valve plate bottom side 4. Due to the circular shape of the projection 41, it is also called a circle. The suction through-hole 16 and the discharge through-hole 21 are located within the circle 41. Between the dotted circle 41 and a further dotted, concentrically arranged, larger circle 42 an annular surface 43 extends that forms a sealing zone of the cylinder of the compressor to be held free of indentations. Between the through-hole 25 and a further dotted circle 45 is located another sealing zone or sealing surface 46 on the valve plate bottom side 4 that has to be held free of indentations. Additionally to the sealing zones or sealing surfaces 43 and 46, also the area of the recess 17 on the valve plate bottom side 4 has to be held free of indentations. The remaining area portions of the valve plate bottom side, which can be relatively uneven, are provided with a plurality of indentations 51, 52.

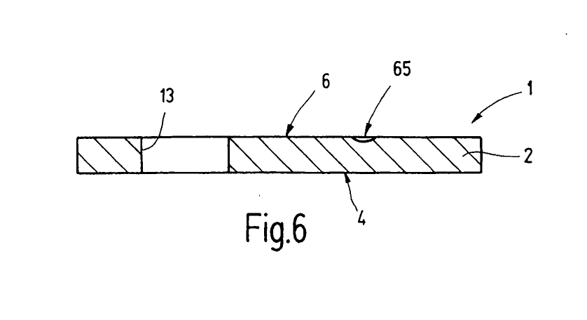

FIG. 5 shows that on the valve plate top side 6, between the outer circumference 55 of the valve plate 1 and a dotted line 56, a further sealing zone 58 extends that also has to be held free of indentations. The dotted line 56 delimits an area portion 60 that can be relatively uneven. A plurality of indentations 61 to 65 are provided in the area portion 60. The indentations 51, 52 and 61 to 65 are pressed into the valve plate bottom side 4 and the valve plate top side 6 after sintering. The depth of the indentations 51, 52 and 61 to 65 is in the range of a few tenths mm. From FIG. 6 it appears that each indentation, seen in the cross-section, has the shape of an arc of a circle.

The first surface area portions of the valve plate 1 with small, that is, very fine tolerances, are also held free of indentations. This particularly goes for the area portions, in which the suction and discharge valves bear on the valve plate 1, in particular the valve seat surfaces (30, 31 in FIG. 3). These first area portions require evenness tolerances of a few μm to ensure a faultless closing of the individual openings by the valves, whereas in these area portions, compared to the remaining surface of the valve plate, the parallelism tolerances are relatively uncritical. For the remaining second area portions of the valve plate evenness tolerances of several hundredths mm are permissible.

For tightness reasons, also parts of the second surface area portions with larger tolerances must be held free of indentations, namely the sealing sections or sealing zones for separating the suction and discharge sides of the compressor, which are formed between the valve plate 1 and a cylinder block or between the valve plate 1 and a cylinder head cover, respectively. To this comes the area portion of the valve plate 1 closing the compression chamber. Here, indentations would increase the harmful dead volume of the compressor. The parts of the second surface area portions, which have to be held free of indentations for sealing reasons, are the sealing zones 43 and 46 on the valve plate bottom side (in FIG. 4) and the sealing zone 58 on the valve plate top side 6 (in FIG. 5).

The leaf valves provided for closing the suction opening 16 and the discharge opening 21 can, in a manner known per se, be fixed on the valve plate 1 by means of pins, screws or rivets, or can be welded or locked on the valve plate 1. For this purpose, they can be located in alignment with the plate surface, or they can be partly or completely located in suitable recesses in the plate. This prevents the dead volume of the compressor, that is, the part of the compression chamber that cannot be emptied at the end of the discharge phase of the compressor. In this connection, the bottom surfaces of these recesses are part of the predetermined first surface area portions with small evenness tolerances.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A valve plate for a reciprocating compressor, the valve plate being a sintered part having on at least one valve plate surface at least one valve seat surface worked after sintering, wherein the valve plate surface has at least one defined area portion with a relatively uneven surface and at least one defined area portion with a relatively even surface.

2. The valve plate according to claim 1, wherein compared to the at least one defined area portion with the relatively even surface, the at least one defined area portion with the relatively uneven surface is so large that the valve plate surface concerned can be manufactured in one stamping step.

3. The valve plate according to claim 2, wherein the at least one defined area portion with the relatively uneven surface is larger than the at least one defined area portion with the relatively even surface.

4. The valve plate according to claim 1, wherein in the area of the valve seat surface(s) [[(30, 31)]] the valve plate surface has a relatively even surface.

5. The valve plate according to claim 1, wherein the area of at least one valve body bearing surface the valve plate surface has a relatively even surface.

6. The valve plate according to claim 4, wherein the valve seat surface and/or the valve body bearing surface are located in the area of recesses or projections.

7. The valve plate according to claim 1, wherein an uncritical part of the relatively uneven surface has indentations or recesses, in which the sintering material, of which the valve plate is made, is locally compressed.

8. The valve plate according to claim 7, wherein the indentations or recesses have a depth of a few tenths mm.

9. The valve plate according to claim 7, characterized in that wherein the indentations or recesses have the shape of a spherical segment, a truncated pyramid segment or a truncated cone segment.

10. The valve plate according to claim 7, wherein a critical part of the relatively uneven surface comprises at least one sealing zone on the valve plate surface.

11. A method for manufacturing a valve plate according to claim 1 involving the following steps:
a. a preferably powdery sintering material is pressed to form a blank;
b. the blank is sintered;
c. the sintered blank is stamped during one single method step.

12. The method according to claim 11, wherein at least one valve seat surface and/or at least one valve body bearing surface is/are calibrated during the only stamping step.

13. The method according to claim 11 wherein through-holes and/or indentations and/or projections of the valve plate are calibrated in the only stamping step.

14. The method according to claim 11, wherein the valve plate surfaces of the sintered and stamped valve plate are sealed.

15. A device for stamping a valve plate surface according to claim 1, by a method comprising the steps of pressing a preferably powdery sintering material to form a blank; sintering the blank; and stamping the sintered blank during one single method step; by means of a stamping tool, wherein the stamping tool has a plurality of projections, which serve the purpose of providing indentations in the at least one defined area portion with a relatively uneven surface.

16. A reciprocating compressor with a cylinder block, in which a compression chamber is formed, delimited on one side by a valve plate according to claim 1 wherein that is clamped between the cylinder block and a cylinder head cover.
